(19) United States
(12) Patent Application Publication
(10) Pub. No.: US 2024/0025511 A1
(43) Pub. Date: Jan. 25, 2024

(54) METHOD FOR CONTROLLING AN ELECTRIC DRIVE OF A TWO-WHEELED VEHICLE AND CONTROL DEVICE FOR PERFORMING THE METHOD

(71) Applicant: Jochen KLIEBER, Tacherting (DE)

(72) Inventor: Jochen KLIEBER, Tacherting (DE)

(21) Appl. No.: 18/355,015

(22) Filed: Jul. 19, 2023

(30) Foreign Application Priority Data
Jul. 21, 2022 (DE) 102022118220.7

(51) Int. Cl. B62M 6/50

(52) U.S. Cl. CPC B62M 6/50

(57) ABSTRACT

A two-wheeled vehicle is drivable via a drive wheel on the basis of rider muscle power introduced into a crank device and of a drive force of an electric drive motor provided at the two-wheeled vehicle. The method includes: detecting torque data related to the drive wheel drive force; determining the presence of a rider drive force demand for the provision of a drive force by the drive motor; determining the presence of a drive condition for the provision of the drive force; controlling the electric drive motor for the provision of the drive force after determining the presence of the rider drive force demand for the provision of a drive force by the drive motor and on determining the presence of the drive condition for the provision of the drive force by the drive motor. A control device is furthermore provided that is configured to perform the method.

### CROSS-REFERENCE TO RELATED APPLICATIONS

This application claims priority to German Patent Application DE 102022118220.7, filed Jul. 21, 2022, which is hereby incorporated by reference in its entirety.

### FIELD OF THE INVENTION

The present invention relates to a method of controlling an electric drive of a two-wheeled vehicle. The present invention additionally relates to a control device for performing the method and to a two-wheeled vehicle having such a control device. The invention in particular relates to a method of controlling an electric drive of a two-wheeled vehicle that is drivable via a drive wheel on the basis of muscle power of a rider of the two wheeled vehicle introduced into a crank device and of a drive force of an electric drive motor provided at the two-wheeled vehicle. To this extent, the invention relates to a method of controlling an electric drive of a two-wheeled vehicle that is configured as an e-bike or pedelec.

### BACKGROUND OF THE INVENTION

Methods of controlling an electric drive of a two-wheeled vehicle designed as an e-bike or pedelec are known. In known two-wheeled vehicles of the category, the drive motor for driving the two-wheeled vehicle is operated when the crank device of the two-wheeled vehicle is operated by the rider. The operation of the drive motor of the two-wheeled vehicle is furthermore interrupted due to regulatory rules when ceasing the operation of the crank device of the two-wheeled vehicle.

### SUMMARY OF THE INVENTION

A method of controlling an electric drive of a two-wheeled vehicle is provided, wherein the two-wheeled vehicle is drivable via a drive wheel on the basis of muscle power introduced into a crank device of the two-wheeled vehicle and of a drive force of an electric drive motor provided at the two-wheeled vehicle. The method has the following steps: detecting torque data that relate to the drive force at the drive wheel of the two-wheeled vehicle;

determining the presence of a drive force demand of the rider for a provision of the drive force by the drive motor;

determining the presence of a drive condition for the provision of the drive force by the drive motor;

controlling the electric drive motor for the provision of the drive force after determining the presence of the drive force demand of the rider for the provision of a drive force by the drive motor and for the provision of the drive force by the drive motor on determining the presence of the drive condition.

The method can be applied to a two-wheeled vehicle that is designed as an e-bike or pedelec. To this extent, the two-wheeled vehicle can be equipped with a crank device whose drive force is transferred to a drive wheel of the two-wheeled vehicle by a transfer means. The two-wheeled vehicle can furthermore have an electric drive motor such that the drive force of the drive motor can be combined with the muscle power introduced via the crank device and can be delivered to the drive wheel.

In accordance with an embodiment, the torque data can comprise at least one torque value or a plurality of torque values that is/are detected in a time sequence or continuously. The step of storing the torque data in a memory device can furthermore be provided. The at least one torque value or the plurality of torque values can here be detected by corresponding detection means. In this respect, the detection can take place via a corresponding means at the drive wheel. Alternatively, the detection of the torque data can take place at a section of a drive train of the two-wheeled vehicle so that these torque data allow a conclusion to be drawn on the drive force at the drive wheel of the two-wheeled vehicle.

In accordance with an embodiment, the step of storing the torque data can take place within a predetermined preceding time period. In this respect, the preceding time period relates to a time period that is before the determining of the presence of the drive force demand. In this respect, the preceding time period in which the torque data are stored can comprise a predetermined time duration that in particular comprises some seconds, for example 5 seconds. Those torque data that were detected before the predetermined preceding time period can in particular be deleted from the memory in the step of storing the torque data. The torque data stored in the step of storing the torque data can be provided for further use for the method.

In accordance with an embodiment, a reference torque can be determined on the basis of the torque data that can in particular be determined by determining a mean value, a maximum value, or a weighted value form the torque data stored within the predetermined time period. In this respect, the reference torque can be stored and can be provided for use in the method. The reference torque can represent a torque that allow a conclusion to be drawn on the drive force that was present at the drive wheel of the two-wheeled vehicle within the predetermined preceding time period. The reference torque can be the last detected torque value before the determining of the presence of the drive force demand.

In accordance with an embodiment, the time elapsed after determining the presence of the drive force demand can be detected, with it being detected that the drive condition is present when the elapsed time after determining the presence of the drive force demand does not exceed a predetermined time duration. In this respect, the predetermined time duration can be preset. Alternatively, the predetermined time duration can be variable or settable. The predetermined time duration in this connection can be in the range from some seconds, for example 3 to 5 seconds. The time duration can be adapted to the demands and is not restricted to the examples.

In accordance with an embodiment, a tilt of the two-wheeled vehicle in the direction of travel with respect to the horizontal can be detected at the position of the two-wheeled vehicle, with it being detected that the drive condition is present when the detected tilt at least corresponds to a predetermined tilt value defining an upward gradient. In this respect, corresponding detection means can be used that are provided at the two-wheeled vehicle to recognize a level difference between a front wheel and a rear wheel of the two-wheeled vehicle. It can in particular be detected in this embodiment whether the two-wheeled vehicle is on an upward gradient, with it being able to be determined whether the upward gradient corresponds to at least a predetermined upward gradient. The predetermined upward gradient can here be set to a value that represents a noticeable upward gradient for the rider. This upward gradient can be in the range from 3-5%, for example. Smaller or greater upward gradient values are conceivable.

In accordance with an embodiment, a step can furthermore be provided to determine an abort condition, with the control of the electric drive motor for providing the drive force after determining the presence of the drive force demand being interrupted on a determination of the presence of the abort condition.

In accordance with an embodiment, the abort condition can be determined in the step for determining an abort condition when the time elapsed after determining the presence of the drive force demand exceeds a predetermined time duration. In this connection, the time is detected that has elapsed after the determination of the presence of the drive force demand. In this respect, the predetermined time duration can be in the range from a plurality of seconds, for example 3 to 5 seconds.

In accordance with an embodiment, the time elapsed after the interruption of the control of the drive motor for providing the drive force can be detected, with it being detected that the drive condition is present if the time elapsed after the interruption of the control of the drive motor for providing the drive force corresponds to at least a predetermined time duration. It can be made possible in this connection that a renewed control of the drive motor for providing the drive force cannot take place directly after the interruption of the control of the drive motor for providing the drive force. In this connection, the predetermined time duration can be in the range of some seconds. The predetermined time duration is preferably in a range of 1 second in the present context.

In accordance with an embodiment, the revolutions taking place at one of the wheels or at a crank device of the two-wheeled vehicle after the interruption of the control of the drive motor for providing the drive force can be detected, with it being detected that the drive condition is present if the revolutions detected after the interruption of the control of the drive motor for providing the drive force corresponds to at least a predetermined number of revolutions. In this respect, the predetermined number of revolutions at one of the wheels can, for example, correspond to a complete revolution. Alternatively, the predetermined number of revolutions at one of the wheels can correspond to a plurality of revolutions, in particular 1 to 5 revolutions. In the event that the number of revolutions of the pedal device of the two-wheeled vehicle is considered, a gear ratio between the pedal device and the drive wheel can be taken into account. To this extent, the predetermined number of revolutions at the crank device of the two-wheeled vehicle can be defined accordingly. For example, the predetermined number of revolutions at the crank device of the two-wheeled vehicle can correspond to 5 to 10 revolutions.

In accordance with an embodiment, the control of the electric drive motor can take place while taking account of the detected torque data. The detected torque data are in particular taken into account on the control of the electric drive motor to the extent that a power of the electric drive motor is suitably set after the determination of the presence of the drive force demand.

In accordance with an embodiment, the drive force can be set in the step of controlling the electric drive motor such that the drive of the two-wheeled vehicle is continued after determining the presence of the drive force demand starting from the drive of the two-wheeled vehicle prior to determining the presence of the drive force demand. It can in particular be effected by this procedure that an interruption of the drive of the electric drive motor can, for example, be suppressed based on a corresponding automated control. In this respect, the continuation of the control of the drive motor can be defined such that the temporarily present drive force at the drive wheel of the two-wheeled vehicles can be maintained within a predetermined abort range.

In accordance with an embodiment, the drive force can be set in the step of controlling the electric drive motor such that the drive force of the two-wheeled vehicle after determining the presence of the drive force demand is substantially held at the drive force of the two-wheeled vehicle prior to determining the presence of the drive force demand. In this embodiment, the drive force at the drive wheel of the two-wheeled vehicle can be held at a value that acts as an uninterrupted drive of the drive wheel due to the taking into account of the detected torque data on the control of the electric drive motor.

In accordance with an embodiment, the control of the electric drive motor for providing the drive force after determining the presence of the drive force demand of the rider can be permitted if the introduction of muscle power by the rider into the crank device is interrupted or if the crank device is not operated by the rider. With conventional two-wheeled vehicles of the category, the drive of the electric drive motor can be interrupted due to the interruption of muscle power by the rider into the crank device or due to the interruption of the operation by the rider. This circumstance can be taken into account by the present method and the interruption of the introduction of muscle power by the rider into the crank device or the interruption of the operation of the crank device by the rider can thus be defined as a condition for the control of the electric drive motor for providing the drive force after determining the presence of the drive force demand of the rider.

In accordance with an embodiment, the drive force demand can be detected by a control element provided at the two-wheeled vehicle, with the control element in particular being able to be configured as a switch element having two switch positions. The switch element can be a push button in this respect. The switch element can be actuated by the rider so that the switch element outputs a signal that can be detected as a drive force demand.

In accordance with an embodiment, the drive force demands can be detected by a control element provided at the two-wheeled vehicle, with the control element being able to be configured as an adjustment element having a continuous settability to specify a desired value of the drive force of the electric drive motor. In this embodiment, the control element can be designed as an adjustment element having a continuous setting range. The control element can in particular be designed as a rotary handle that can be operated within the setting range by the rider. The control element designed as an adjustment element can output a signal that represents a quantitative drive force demand. The amount of the drive force can in particular be specified in connection with the drive force demand by the rider using the control element that is designed as an adjustment element. The signal output by the control element designed as an adjustment element can be used in the method to set the drive force of the drive motor corresponding to the actuation of the control element designed as an adjustment element in the step to control the electric drive motor.

In a further embodiment, the control element can be designed with a combination of a switch element and an adjustment element in accordance with the embodiments explained above.

In accordance with a further aspect, a two-wheeled vehicle is provided that has a crank device and an electric drive motor. In this respect, the two-wheeled vehicle is drivable via a drive wheel by the muscle power of a rider of the two-wheeled vehicle introduced into the crank device and by a drive force of the electric drive motor. The control device furthermore has an input interface to receive signals at least from a control element and from means provided at the two-wheeled vehicle for detecting torque data. The control device furthermore has an output interface for outputting control signals to control the electric drive motor. The control device in accordance with the present aspect is configured to perform the method in accordance with one or more of the preceding embodiments.

The control device can be a separate element in accordance with an embodiment. Alternatively, the control device can be integrated in a two-wheeled vehicle control device that satisfies further functions in addition to the functions described above.

In accordance with a further aspect, a two-wheeled vehicle is provided that has a crank device and an electric drive motor. In this respect, the two-wheeled vehicle is drivable via a drive wheel by the muscle power of a rider of the two-wheeled vehicle introduced into the crank device and by a drive force of the electric drive motor. The two-wheeled vehicle in accordance with the present aspect furthermore has a control device in accordance with the above aspect.

### BRIEF DESCRIPTION OF THE DRAWINGS

FIG. 1 shows a method flowchart for detecting and storing torque data in accordance with an embodiment in a schematic representation; and

FIG. 2 shows a method flowchart for controlling an electric drive motor in accordance with an embodiment in a schematic representation.

### DETAILED DESCRIPTION OF THE INVENTION

The basic concept of the present invention will be described in the following with reference to the drawings. The starting point of the present invention will first be explained.

The starting point for the basic concept of the present invention is a two-wheeled vehicle that is designed as a pedelec or e-bike. Such two-wheeled vehicles have a crank device that is operable by muscle power of the rider to drive a drive wheel of the two-wheeled vehicle via a transmission means such as a chain drive. Such two-wheeled vehicles of the category have an electric drive motor that is coupled to the drive wheel of the two-wheeled vehicle so that the drive force of the electric drive motor can be transmitted to the drive wheel of the two-wheeled vehicle. To this extent, there is the possibility with such two-wheeled vehicles of the category to combine the muscle power of the rider with the drive force of the electric drive motor. There is typically the possibility with such two-wheeled vehicles to drive the two-wheeled vehicle exclusively by muscle power that is introduced into the crank device while the electric drive motor is not operated. In the event that the crank device is operated by the rider, the electric drive motor can additionally be operated. As a rule, with such two-wheeled vehicles, the operation of the electric drive motor is suppressed as soon as the crank device is not operated by the rider.

Situations in which the operation of the crank device cannot be operated due to external influences so that the total propulsion of the two-wheeled vehicle is directly interrupted have previously remained out of consideration in the operation of such two-wheeled vehicles. Such situations can arise, for example, when riding takes place in rough terrain and there is a risk that the crank device touches the ground during operation and that this may lead to a risk of an accident. If riding simultaneously takes place at an upward gradient, the interruption of operation of the crank device would result in the direct interruption of the propulsion of the two-wheeled vehicle. In certain situations, the interruption of the propulsion of the two-wheeled vehicle cannot only have the consequence of a loss of comfort, but can also represent the cause of an increased risk of an accident.

The above circumstance is taken into account by the present invention. An embodiment that solves the above problem will be described in the following.

In accordance with the present embodiment, the two-wheeled vehicle has a control device that is configured to carry out the control of the electric drive motor. The control device is in particular configured to control the drive force of the electric drive device in accordance with predetermined specifications. For this purpose, electric power is taken from an electric energy storage device that is mounted on the two-wheeled vehicle and is supplied to the electric drive motor according to the power demand.

The control device furthermore has input interfaces that are configured to receive signals. On the one hand, a signal is supplied from a control element that is provided at the two-wheeled vehicle and that is formed as a switch element having two switch positions. To this extent, the control device can detect whether the switch element is actuated by a rider or not.

On the other hand, signals that allow a conclusion to be drawn on the torque or the drive force at the rear wheel are supplied to the input interfaces of the control device. In the present embodiment, a torque sensor that emits a signal that represents the torque present at the rear wall is provided at the drive wheel that is the rear wheel of the two-wheeled vehicle. This signal is likewise supplied to the control device.

In accordance with the present embodiment, the drive of the electric drive device is interrupted in a typical manner by the two-wheeled vehicle control device as soon as it is detected that the crank device is not operated by the rider to satisfy regulatory demands.

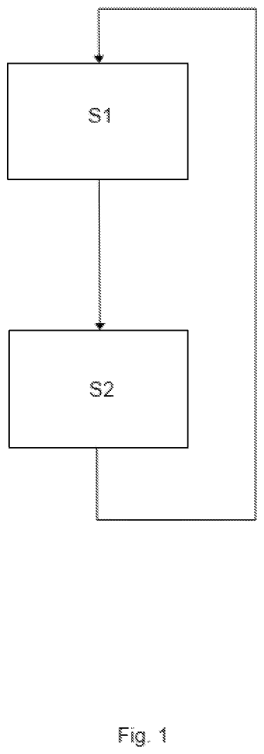

With reference to FIG. 1, the signal of the torque sensor at the drive wheel of the two-wheeled vehicle is first detected in a step Si. In this respect, the detection of the torque at the drive wheel of the two-wheeled vehicle takes place continuously. In a following step S2, torque values are stored at predetermined time intervals in a storage device provided in the control device. In this respect, in a non-restrictive example, a torque value is stored in the storage device of the control device every 100 ms. The storage of the torque values takes place continuously, but such torque values that were detected and stored before a time that corresponds to a preset period of time are deleted. This time duration can amount to 5 seconds in an embodiment. To this extent, torque values of the torque sensor at the drive wheel of the two-wheeled vehicle from the preceding 5 seconds are present in the storage device.

The last torque value is defined as the reference torque value in the present embodiment.

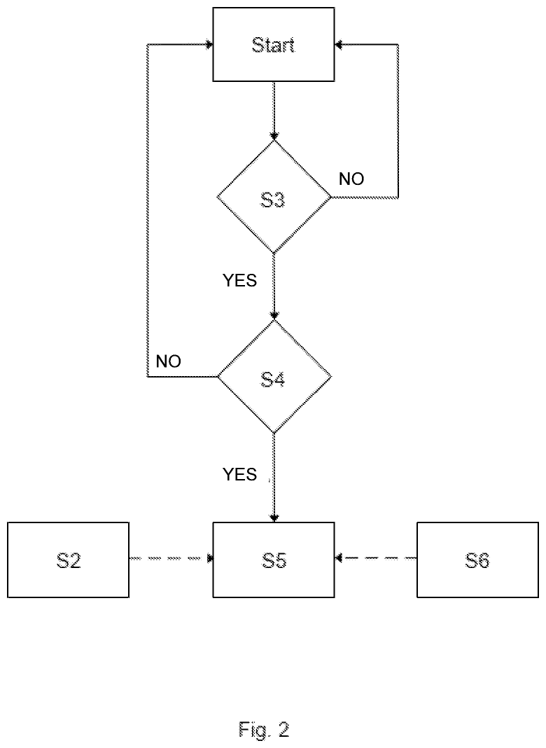

The procedure of FIG. 2 will be explained in the following and the relationship with the procedure of FIG. 1 will be explained. The method shown in FIG. 2 begins at Start and is carried out continuously at predetermined short time periods. Once the method of FIG. 2 has been started, a determination whether a drive force demand is present is made in step S3. This determination in step S3 is carried out by querying the control element provided as a switch element. In the event that the rider of the two-wheeled vehicle actuates the control element, the query in step S3 is positive. As long as the rider does not actuate the control element, the query in step S3 is negative. In the event that the rider of the two-wheeled vehicle actuates the control element, the method is continued with step S2 to determine the presence of a drive condition. In the present embodiment, the query of step S4 takes place by determining the operating state of the crank device. In the event that the crank device of the two-wheeled vehicle is operated, a determination that a drive condition is not present is made in step S4. In the event that a determination is made in step S4 that the crank device is operated, a determination is made that a drive condition is present. In this case, the method is continued step S5. In the event that the queries in steps S3 and S4 are negative, the method is returned to the start.

The electric drive motor is controlled in step S5. In this connection, as shown in FIG. 2, the procedure shown in FIG. 1 is taken into account. The content of the storage device, in particular the relevant reference torque, is in particular taken into account in step S5 to control the electric drive motor. The result of a step S6 to determine an abort condition, that will be explained in the following, is furthermore taken into account in step S5 to control the electric drive motor.

In the event that step S5 to control the electric drive motor is carried out after the queries of steps S3 and S4, the reference torque is first set as the desired torque of the electric drive motor that was stored in the procedure in step S2 shown in FIG. 1. A check is furthermore continuously made in step S6 to determine the abort condition whether an abort condition for the control of the electric drive motor is present. In the event that no abort condition is determined in step S6, the electric drive motor is driven on the basis of the reference torque.

In the present embodiment, the control of the electric drive motor is continued with the reference torque for a predetermined period of time. In the event that the predetermined period of time has elapsed, a determination that an abort condition is present is made in step S6. To this extent, the control of the electric drive motor is interrupted after the end of the predetermined period of time that can be in the range of 5 seconds in the present embodiment.

A specific application of the control method in accordance with the present embodiment will be explained in the following. In a starting situation, the rider rides the two-wheeled vehicle on very rough terrain at a predetermined speed. In accordance with a scenario, the rider recognizes that the crank device and in particular the envelope of the pedals attached to the crank device would touch the ground on continued operation, which is to be avoided. The rider will thus intuitively cease the operation of the crank device to avoid the collision of the crank device with the ground.

In this situation, a typical two-wheeled vehicle of the category, that is designed as a pedelec or e-bike, would directly interrupt the drive of the electric drive motor since it has been determined that the operation of the crank device has been ceased.

In a two-wheeled vehicle that is equipped with the above-described functionality, the rider will actuate the control element directly after ceasing the operation of the crank device so that the operation of the electric drive motor is continued, as was explained above with reference to the procedure of FIG. 2. The electric drive motor is in particular operated with a drive power that takes account of the last stored torque value at the drive wheel of the two-wheeled vehicle. The travel of the two-wheeled vehicle is thus continued substantially seamlessly directly after the actuation of the control element and the risk of accident can thereby be reduced and the comfort of the trip can be improved.

The two-wheeled vehicle is moved out of the region in which there is a risk of a collision of the crank device with the ground due to the continued drive of the electric drive motor. To this extent, the rider can take up the operation of the crank device again as soon as the risk of a collision of the crank device with the ground is no longer present. For this reason, a period of time is defined as an abort condition after whose elapse the control of the electric drive motor is interrupted if the crank device is not continued to be operated by the rider. If the operation of the crank device is taken up again during this period of time, the operation of the electric drive motor is initiated again as is customary in two-wheeled vehicles of the category that are designed as pedelecs or e-bikes.

In a different embodiment, a control element is provided at the two-wheeled vehicle that is configured as an adjustment element having continuous settability to specify a desired value of the drive force of the electric drive motor. Unlike the preceding embodiment, the rider can actuate the adjustment element and thus specify the drive power to continue the drive of the two-wheeled vehicle in a situation that has been described above. In this embodiment, the torque data that are stored in step S2 in the procedure shown in FIG. 1 can be taken into account in an alternative and can in particular serve as a start torque as soon as the rider actuates the adjustment element. In an alternative embodiment, the control of the electric drive motor can take place independently of the torque data stored in step S2. There is in particular the possibility in this alternative that the rider carries out the drive force at the drive wheel of the two-wheeled vehicle by a corresponding setting at the adjustment element.

In a further embodiment, a determination is made in step S4 to determine the presence of a drive condition whether a predetermined time has elapsed since the interruption of the control of the electric drive motor or not. This predetermined time can, for example, be set to 1 second. As long as this predetermined time since the aborting of the control of the electric drive motor has not elapsed, step S5 to control the electric drive motor is not performed. It is ensured in this embodiment that a continuous electric drive of the two-wheeled vehicle is suppressed due to the actuation of the control element. Alternatively or additionally, the number of wheel revolutions that have taken place since the aborting of the control of the electric drive motor can be detected as a further drive condition that is determined in step S4 to determine the presence of a drive condition. If, for example, one of the wheels has turned by, for example, less than a predetermined number of revolutions, for example one revolution, since the aborting of the control of the electric drive motor, the control of the electric drive motor carried out in step S5 is suppressed. In a similar manner. the number of revolutions of the crank device, that can, for example, comprise a number of five revolutions, can be used as a drive condition in the determination of step S4. In this alternative embodiment, on the falling below of the predetermined number of revolutions of the crank device since the aborting of the control of the electric drive motor, the drive of the electric drive motor can thus be suppressed.

In a further alternative embodiment, the upward gradient where the two-wheeled vehicle currently is can be taken into account as a drive condition of step S4. For this purpose, for example, a determination whether the two-wheeled vehicle is at an upward gradient relative to the horizontal can be determined by an inclinometer or a similar detection means. It can thus be taken into account in step S4 to determine the presence of a drive condition that the drive condition is only present when the two-wheeled vehicle is on an upward gradient that has at least a predetermined upward gradient angle. The advantage of the present invention becomes particularly clear with this embodiment since the direct interruption of the propulsion of a two-wheeled vehicle of the category at an upward gradient in particular represents a hazard source in rough terrain.

The above concept can be applied to two-wheeled vehicles having different drive concepts. Different drive motors can in particular be used, for example a middle motor and a wheel hub motor. The design of the two-wheeled vehicle to which the method is applicable is variable overall as long as a crank device and an electric drive motor are provided.

### REFERENCE NUMERALS

S1 detecting torque data

S2 storing torque data

S3 determining a drive force demand

S4 determining the presence of a drive condition

S5 controlling the electric drive motor

S6 determining the abort condition

1. A method of controlling an electric drive of a two-wheeled vehicle that is drivable via a drive wheel on the basis of muscle power of a rider introduced into a crank device of the two-wheeled vehicle and of a drive force of an electric drive motor provided at the two-wheeled vehicle having the following steps:
detecting torque data that relate to the drive force at the drive wheel of the two-wheeled vehicle;
determining a presence of a drive force demand of the rider for a provision of a drive force by the drive motor;
determining the presence of a drive condition for the provision of the drive force by the drive motor;
controlling the electric drive motor for the provision of the drive force after determining the presence of the drive force demand of the rider for the provision of a drive force by the drive motor and for the provision of the drive force by the drive motor on determining the presence of the drive condition.

2. The method in accordance with claim 1, wherein the torque data comprise at least one torque value or a plurality of torque values that is/are detected in a time sequence or continuously, further comprising a step of storing the torque data in a storage device.

3. The method in accordance with claim 2, wherein the step of storing the torque data takes place within a predetermined preceding time period.

4. The method in accordance with claim 3, wherein a reference torque is determined on the basis of the torque data that is determined by determining a mean value, a maximum value, or a weighted value form the torque data stored within the predetermined time period.

5. The method in accordance with claim 1, wherein a time elapsed after determining the presence of the drive force demand is detected, with it being detected that the drive condition is present when the elapsed time after determining the presence of the drive force demand does not exceed a predetermined time duration.

6. The method in accordance with claim 1, wherein a tilt of the two-wheeled vehicle in a direction of travel with respect to a horizontal is detected at a position of the two-wheeled vehicle, with it being detected that the drive condition is present when the detected tilt at least corresponds to a predestined tilt value defining an upward gradient.

7. The method in accordance with claim 1, further comprising a step to determine an abort condition, wherein the control of the electric drive motor for providing the drive force after determining the presence of the drive force demand is interrupted on a determination of the presence of the abort condition.

8. The method in accordance with claim 7, wherein the abort condition is determined in the step for determining an abort condition when a time elapsed after determining the presence of the drive force demand exceeds a predetermined time duration.

9. The method in accordance with claim 7, wherein the time elapsed after the interruption of the control of the drive motor for providing the drive force is detected, with it being detected that the drive condition is present if the time elapsed after the interruption of the control of the drive motor for providing the drive force corresponds to at least a predetermined time duration.

10. The method in accordance with claim 7, wherein revolutions taking place at one of the wheels or at the crank device of the two-wheeled vehicle after the interruption of the control of the drive motor for providing the drive force is detected, with it being detected that the drive condition is present if the revolutions detected after the interruption of the control of the drive motor for providing the drive force corresponds to at least a predetermined number of revolutions.

11. The method in accordance with claim 1, wherein the control of the electric drive motor takes place while taking account of the detected torque data.

12. The method in accordance with claim 11, wherein the drive force is set in the step of controlling the electric drive motor such that the drive of the two-wheeled vehicle is continued after determining the presence of the drive force demand starting from the drive of the two-wheeled vehicle prior to determining the presence of the drive force demand.

13. The method in accordance with claim 11, wherein the drive force is set in the step of controlling the electric drive motor such that the drive force of the two-wheeled vehicle after determining the presence of the drive force demand is substantially held at the drive force of the two-wheeled vehicle prior to determining the presence of the drive force demand.

14. The method in accordance with claim 1, wherein the control of the electric drive motor for providing the drive force after determining the presence of the drive force demand of the rider is permitted if the introduction of muscle power by the rider into the crank device is interrupted or if the crank device is not operated by the rider.

15. The method in accordance with claim 1, wherein the drive force demand is detected by a control element provided at the two-wheeled vehicle.

16. The method in accordance with claim 15, wherein the control element is configured as a switch element having two switch positions.

17. The method in accordance with claim 1, wherein the drive force demand is detected by a control element provided at the two-wheeled vehicle, with the control element being configured as an adjustment element having a continuous settability to specify a desired value of the drive force of the electric drive motor.

18. A control device for a two-wheeled vehicle having a crank device and an electric drive motor, wherein the two-wheeled vehicle is drivable via a drive wheel by muscle force of a rider of the two-wheeled vehicle introduced into the crank device and a drive force of the electric drive motor having an input interface to receive signals at least from a control element and from means provided at the two-wheeled vehicle to detect torque data and having an output interface to output control signals to control the electric drive motor, with the control device being configured to perform the method in accordance with claim 1.

19. A two-wheeled vehicle having a crank device and an electric drive motor, wherein the two-wheeled vehicle is drivable via a drive wheel by muscle force of a rider of the two-wheeled vehicle introduced into the crank device and a drive force of the electric drive motor furthermore having a control device in accordance with claim 18.
